(19) United States
(12) Patent Application Publication
(10) Pub. No.: US 2015/0213476 A1
(43) Pub. Date: Jul. 30, 2015

(54) DISPLAYING LOYALTY MEMBERSHIP OPPORTUNITIES

(71) Applicants: Andrew FOSTER, Naremburn (AU); Jonah JONES, Darlinghurst (AU)

(72) Inventors: Andrew FOSTER, Naremburn (AU); Jonah JONES, Darlinghurst (AU)

(73) Assignee: GOOGLE INC., Mountain View, CA (US)

(21) Appl. No.: 13/526,433

(22) Filed: Jun. 18, 2012

(51) Int. Cl. G06Q 30/02

(52) U.S. Cl. CPC G06Q 30/0226

(57) ABSTRACT

A computer-implemented method of identifying businesses that honor loyalty programs. The method includes receiving a request for businesses that have a loyalty program within a predetermined proximity to a user, the request including location information of the user, accessing a list of loyalty programs associated with the user, and comparing the list of loyalty programs associated with the user to businesses listings in a business data repository, each business listing having an associated address and a list of loyalty programs honored by the business. The method also includes identifying those businesses that honor at least one of the loyalty programs listed in the loyalty programs associated with the user, selecting the identified businesses that are within the predetermined proximity to the user, and providing a list of the selected businesses to the user.

### BACKGROUND

The present disclosure generally relates to loyalty membership programs.

Using a particular type of credit card or a loyalty card when making a payment at a store often has benefits to a consumer. For example, a discount on wine may be received by the consumer when paying at a restaurant with a particular credit card. For another example, airline points may be accrued by using a loyalty card when buying electronic goods.

However, keeping track of available discounts and rewards can be difficult. As such, factoring those discounts and rewards into decisions about what businesses to patronize can be particularly difficult.

### SUMMARY

According to one aspect of the present disclosure, a computer-implemented method of identifying businesses that honor loyalty programs is provided. The method includes receiving a request for businesses that have a loyalty program within a predetermined proximity to a user, the request including location information of the user, accessing a list of loyalty programs associated with the user, and comparing the list of loyalty programs associated with the user to businesses listings in a business data repository, each business listing having an associated address and a list of loyalty programs honored by the business. The method also includes identifying those businesses that honor at least one of the loyalty programs listed in the loyalty programs associated with the user, selecting the identified businesses that are within the predetermined proximity to the user, and providing a list of the selected businesses to the user.

According to another aspect of the present disclosure, a system for identifying businesses that honor loyalty programs is provided. The system includes one or more processors and a machine-readable medium comprising instructions stored therein. When executed by the processor(s), the instructions cause the processors to perform operations including receiving a request for businesses that have a loyalty program within a predetermined proximity to a location, the request including information from the user about the location, accessing a list of loyalty programs associated with the user, and comparing the list of loyalty programs associated with the user to businesses listings in a business data repository, each business listing having an associated address and a list of loyalty programs honored by the business. The instructions also cause the processors to perform operations including identifying those businesses that honor at least one of the loyalty programs listed in the loyalty programs associated with the user, selecting the identified businesses that are within the predetermined proximity to the location, and providing a list of the selected businesses to the user.

According to a further aspect of the present disclosure, a machine-readable medium is provided. The machine-readable medium includes instructions stored therein, which when executed by a machine, cause the machine to perform operations for identifying businesses that honor loyalty programs. The operations include receiving a request for businesses that have a loyalty program within a predetermined proximity to a user, the request including location information of the user, accessing a list of loyalty programs associated with the user, and comparing the list of loyalty programs associated with the user to businesses listings in a business data repository, each business listing having an associated address and a list of loyalty programs honored by the business. The operations also include identifying those businesses that honor at least one of the loyalty programs listed in the loyalty programs associated with the user, selecting the identified businesses that are within the predetermined proximity to the user, and providing a map showing the selected businesses to the user.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example of an interface for creating a loyalty wallet according to certain aspects of the disclosure.

FIG. 2 illustrates another example of an interface for creating a loyalty wallet according to certain aspects of the disclosure.

FIG. 3 illustrates an example of an architecture for identifying businesses using a loyalty wallet according to certain aspects of the disclosure.

FIG. 4 is a block diagram illustrating examples of a client and a server from the architecture of FIG. 3 according to certain aspects of the disclosure.

FIG. 5 is a flowchart illustrating an example of operations for setting up a loyalty wallet according to certain aspects of the disclosure.

FIG. 6 is a flowchart illustrating an example of operations for identifying businesses based on a user's loyalty wallet according to certain aspects of the disclosure.

FIG. 7 illustrates an example of a map-based interface that presents information about businesses that honor a user's loyalty programs according to certain aspects of the disclosure.

FIGS. 8 and 9 illustrate an example of a search-based interface that presents information about businesses that honor a user's loyalty programs according to certain aspects of the disclosure.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

Although certain examples provided herein describe a user's information (e.g., membership in loyalty programs, used program, and the like) being stored in memory, the user can, at any time, delete the user information from memory and/or opt out of having the user information stored in memory. Additionally, the user can, at any time, adjust appropriate privacy settings to selectively limit the types of user information stored in memory, or select the memory in which the user information is stored (e.g., locally on the user's device as opposed to remotely a server). The user information does not include and/or share the specific identification of the user (e.g., the user's name) unless otherwise specifically provided or directed by the user.

Using a particular type of credit card or a loyalty card when making a payment at a store often has benefits to a consumer. Loyalty programs associated with such cards provide loyalty offers to their members. Examples of the loyalty programs include but are not limited to programs associated with certain credit or debit cards, frequent flyer programs, discount programs, programs offered by associations, professional organizations, and non-professional organizations, and the like. Loyalty offers provided by such loyalty programs can be for financial or non-financial rewards. Examples of loyalty offers include but are not limited to offers for cash back rewards, discounts, program points, frequent flyer miles, and the like.

For example, a discount on wine may be received by the consumer when paying at a restaurant with a particular credit card. For another example, airline points may be accrued by citing a loyalty card when buying electronic goods.

However, keeping track of available discounts and rewards can be difficult. As such, factoring those discounts and rewards into decisions about what businesses to patronize can be particularly difficult.

In one aspect, the present technology addresses this issue by helping a consumer identify businesses that honor one or more loyalty programs associated with him or her. A business can honor a loyalty program by offering some type reward or benefit (i.e., a “loyalty offer”) to members of that loyalty program.

According to certain aspects of the present technology, one method for identifying businesses that honor loyalty programs includes receiving a request for businesses that have a loyalty program within a predetermined proximity to a user, the request including location information of the user, accessing a list of loyalty programs associated with the user, and comparing the list of loyalty programs associated with the user to businesses listings in a business data repository, each business listing having an associated address and a list of loyalty programs honored by the business. The method also includes identifying those businesses that honor at least one of the loyalty programs listed in the loyalty programs associated with the user, selecting the identified businesses that are within the predetermined proximity to the user, and providing a list of the selected businesses to the user.

A list of loyalty programs associated with a user is a “loyalty wallet” according to aspects of the disclosure. In some aspects, a consumer creates a loyalty wallet by entering information about their membership in frequent airline programs, types of credit cards, organizations or associations, and the like, and this information is stored in the loyalty wallet. Additional information such as a consumer's current point total, membership level, or the like, can be entered by the consumer. In other aspect, such information can be acquired from the loyalty program provider(s) based on the information entered by the consumer. Of course, permission to access this data would be secured before doing so. Portions of these aspects can be combined.

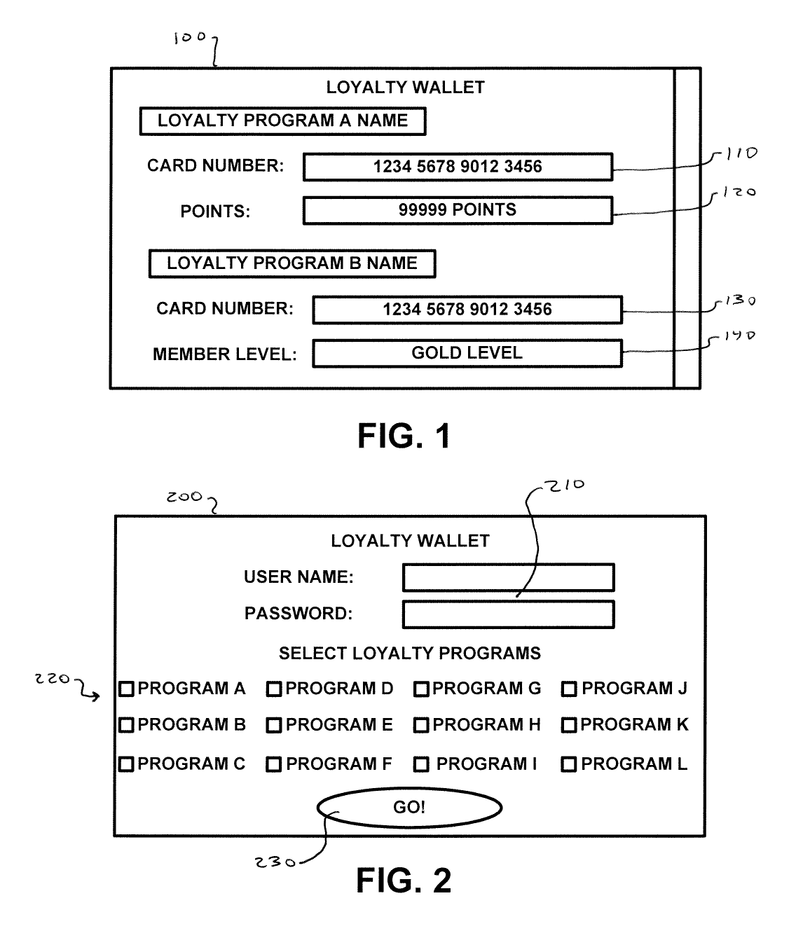

FIG. 1 illustrates an example of an interface for creating a loyalty wallet according to certain aspects of the disclosure. Interface 100 is displayed, for example, by a loyalty program helper site after a user logs into the site. The interface can be displayed by other programs and sites as well.

In interface 100 of FIG. 1, a user enters a set of loyalty program names. In one aspect, the loyalty helper site displays a set of data entry areas that differ depending on the entered name. Thus, FIG. 1 shows CARD NUMBER and POINTS entry areas 110 and 120 for LOYALTY PROGRAM A NAME, and CARD NUMBER and MEMBER LEVEL entry areas 130 and 140 for LOYALTY PROGRAM B NAME.

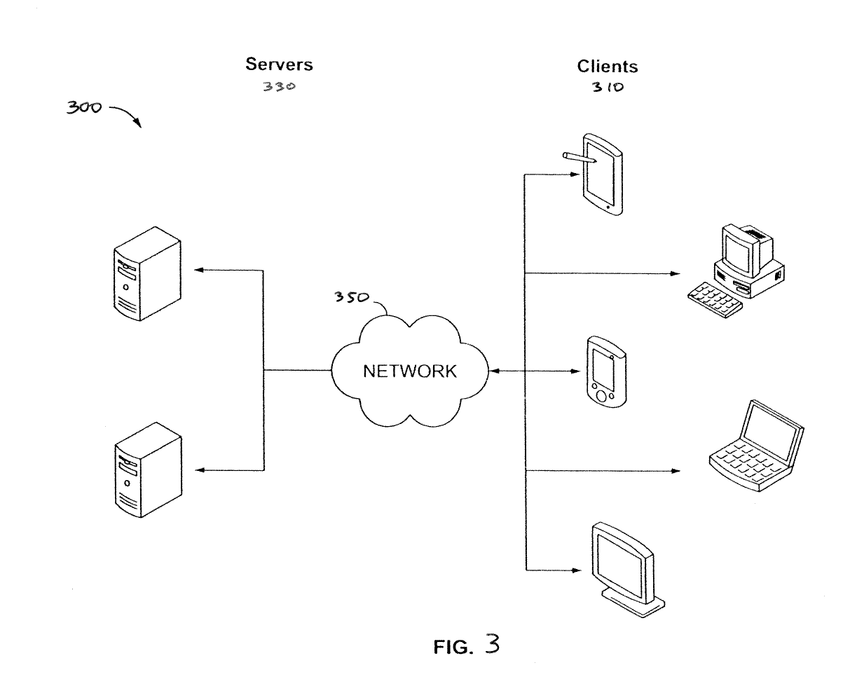

FIG. 2 illustrates another example of an interface for creating a loyalty wallet according to certain aspects of the disclosure. Interface 200 in FIG. 2 includes sign-in area 210, loyalty programs area 220, and activation button 230. The user signs into a loyalty helper site using sign in area 210 and selects one or more loyalty programs in loyalty program area 220. Check boxes are provided in loyalty programs area 220 for a user to select one ore more of the listed loyalty programs. Other selection techniques can be provided. The user instructs the loyalty helper site to gather the user's loyalty program information from providers for those programs by using activation button 230.

In some cases, a user may have to provide additional identifying information such as an address, phone number, or other identifying data. In other cases, the loyalty helper site provider may already have some or all of this information.

Similar user interfaces can be used to edit an existing loyalty wallet. For example, interfaces 100 and 200 can be configured to show loyalty programs to which a user already belongs, and the user can deselect, add, edit, or delete information for those loyalty programs if so desired.

The interfaces shown in FIGS. 1 and 2 can include additional features that are not shown. For example, a “Terms of Service” pop-up could be added to ensure that a user consents to the actions that he or she is requesting the loyalty helper site provider to take. Various aspects of these interfaces also can be combined, for example to permit a user to fill out part of their loyalty program information and to have the loyalty helper site provider gather the rest of the information.

Other techniques and interfaces for creating and editing a loyalty wallet also can be used according to aspects of the disclosure. For example, a call-in line could be provided for verbal entry and/or editing of a user's loyalty wallet.

Once created, a user's loyalty wallet is used according to aspects of the present technology to find businesses that honor one or more loyalty programs to which the user belongs. For example, the loyalty programs are compared to businesses listings in a business data repository. Each business listing in the repository has an associated address and a list of loyalty programs honored by the business. Those businesses within a predetermined proximity to a location of the user that honor at least one of the loyalty programs listed in the user's loyalty wallet are identified, and the identified businesses within a predetermined proximity to the user are selected. A list or map showing the selected businesses is provided to the user.

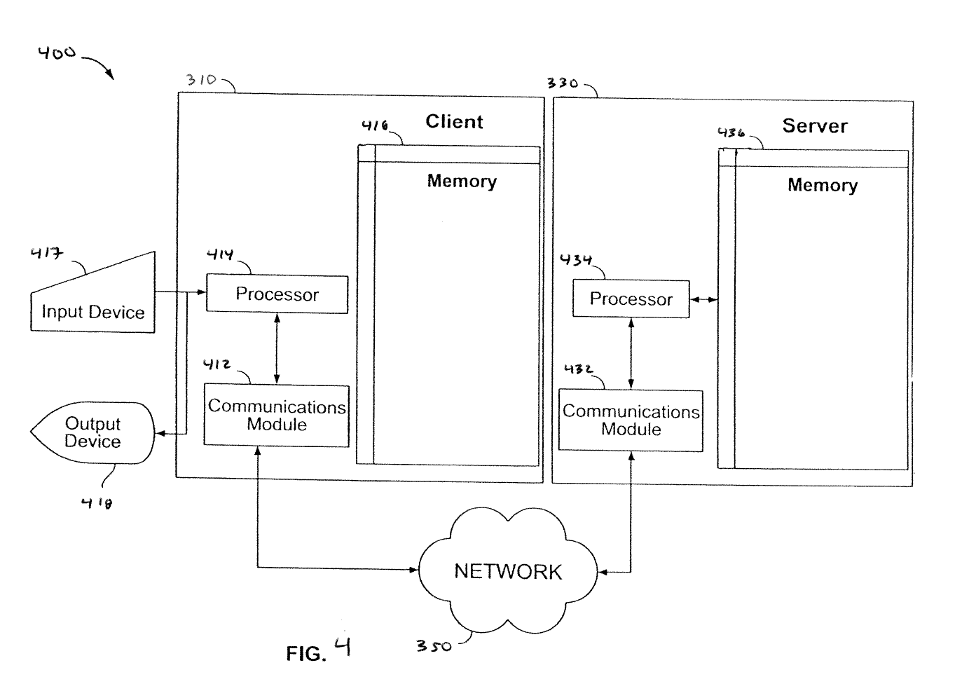

FIG. 3 illustrates an example of an architecture for identifying businesses using a loyalty wallet according to certain aspects of the disclosure. The architecture 300 includes servers 330 and clients 310 connected over a network 350. One of the many servers 330 is configured to host instructions and data, including without limitation loyalty wallets, one or more business data repositories, and instructions for identifying businesses that honor loyalty programs using the loyalty wallets and business data according to aspects of the disclosure. Alternatively, multiple servers 330 can host these data and instructions (or portions thereof) for purposes of load balancing, or one of the many clients can execute the instruction without the assistance of a server.

Clients 310 and servers 330 can be any computing devices having one or more processors, memory, and communications capability necessary to perform some or all of the operations disclosed herein. Clients 310 to which servers 330 are connected over the network 350 can be, for example, desktop computers, mobile computers, tablet computers (e.g., including e-book readers), mobile devices (e.g., a smartphones or personal digital assistants), set top boxes (e.g., for a television with one or more processors coupled thereto and/or embedded therein), video game consoles, or any other devices having memory, one or more processors, and communications capabilities for identifying businesses that honor loyalty programs according to certain aspects of this disclosure.

The network 350 can include, for example, any one or more of a personal area network (PAN), a local area network (LAN), a campus area network (CAN), a metropolitan area network (MAN), a wide area network (WAN), a broadband network (BBN), a peer-to-peer network, an ad-hoc network, the Internet, and the like. Further, the network can include, but is not limited to, any one or more network topologies such as a bus network, a star network, a ring network, a mesh network, a star-bus network, tree or hierarchical network, and the like.

FIG. 4 is a block diagram 400 illustrating examples of client 310 and server 330 in architecture 300 of FIG. 3 according to certain aspects of the disclosure. Client 310 and server 330 are connected over the network 350 via respective communications modules 412 and 432. Communications modules 412 and 432 are configured to interface with network 350 to send and receive information, such as data, requests, responses, and commands to other devices on the network. Communications modules 412 and 432 can be, for example, modems or Ethernet cards.

According to aspects of the present disclosure, a loyalty wallet for a user can be stored in memory 416 of client 310. According to other aspects of the present disclosure, loyalty wallets for users can be stored in memory 436 of server 330. Other arrangements for storing loyalty wallets can be used.

A loyalty wallet associates a user with a set of loyalty programs, for example as described above. Thus, a loyalty wallet includes a user's identity information and loyalty program information. The loyalty program information can include a loyalty program identifier, the user's membership identifier (e.g., a card number), and possibly additional information such as a user's point total or member level. Some or all of this information can be included, and additional information can be included as well.

Memory 416 of client 310 or memory 436 of serve 330 also stores a repository of business data according to aspects of the disclosure. Each business listing in the business data repository has an associated address and a list of loyalty programs honored by the business. Additional information such as point or member level requirements, offer expiration dates, and the like also can be included for each business. Some or all of this information can be included, and additional information can be included as well.

According to aspects of the present disclosure, instructions for using a loyalty wallet and business data to help a user to identify businesses that honor one or more of the user's loyalty programs can be stored in memory 416 of client 310. According to other aspects of the present disclosure, these instruction can be stored in memory 436 of server 330.

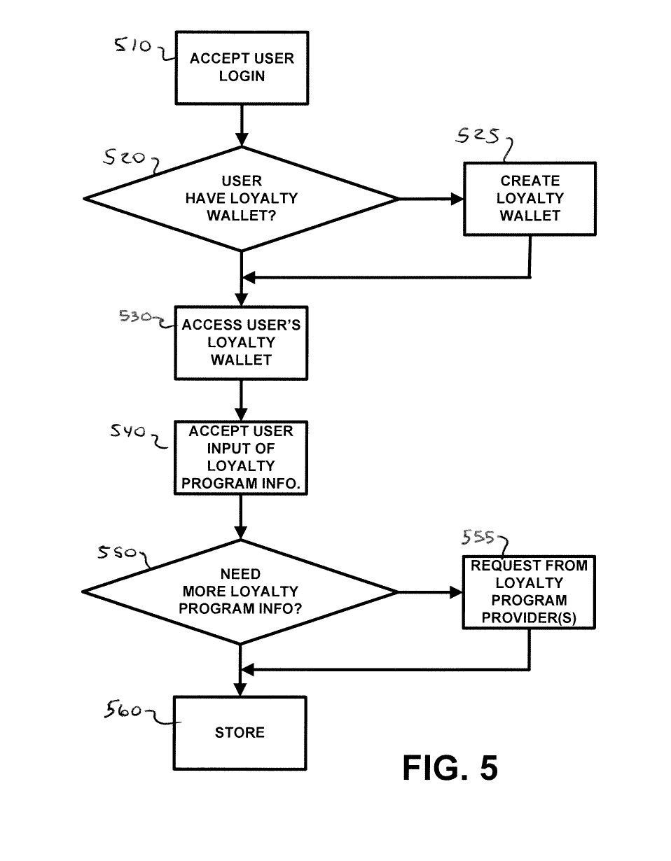

FIG. 5 is a flowchart illustrating an example of operations for setting up a loyalty wallet according to certain aspects of the disclosure. The operations shown in FIG. 5 can be implemented by one or more processors configured to do so, for example via instructions stored in memory or other storage. The processors can be configured in other ways as well, for example but not limited to via firmware or physical design.

In a step 510, a user's login is accepted. Alternatively, the user could already be logged in or otherwise authenticated. A determination is made in step 520 about whether the user already has a loyalty wallet. If not, an empty loyalty wallet is created in step 525.

If the user's loyalty wallet exists, the loyalty wallet is accessed in step 530. Input of loyalty program information is accepted in step 540, for example through interfaces such as those described above with respect to FIGS. 1 and 2. Once the user has input their loyalty program information, a determination is made in step 550 about whether more program information is needed. If more information is needed, that information is requested from loyalty program providers in step 555. Alternatively, additional information can be requested from other sources.

The user's loyalty wallet is stored in step 560 for later use, for example to help a user identify businesses that honor one or more of the user's loyalty programs. The loyalty wallet can be stored locally in a client, remotely on a server or servers, or elsewhere.

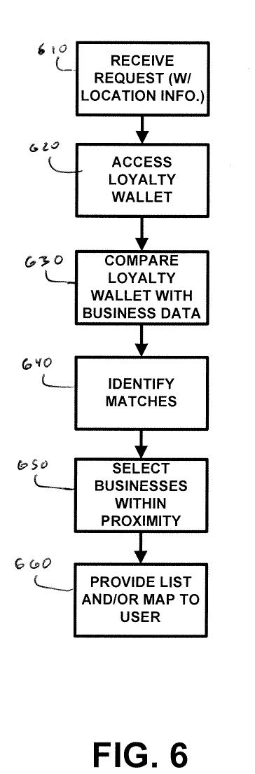

FIG. 6 is a flowchart illustrating an example of operations for identifying businesses based on a user's loyalty wallet according to certain aspects of the disclosure. The operations shown in FIG. 6 can be implemented by one or more processors configured to do so, for example via instructions stored in memory or other storage. The processor(s) can be configured in other ways as well, for example but not limited to via firmware or physical design.

In step 610, a request is received for businesses within a predetermined proximity to a location that honor at least one of a user's loyalty programs. The request includes information from the user about the location. The location can be a location of the user or a location supplied by the user. In one aspect, the location information is provided by a location aware device such as but not limited to a user's GPS enabled smart phone or other mobile device. In another aspect, the location information is entered by the user into a website or application program. The location can be provided in other ways as well.

A list of loyalty programs associated with the user is accessed in step 620. This list can be accessed from the user's loyalty wallet stored locally in a client device, remotely on a server or servers, or elsewhere. In step 630, the list of loyalty programs associated with the user are compared to businesses listings in a business data repository. Each business listing has an associated address and a list of loyalty programs honored by the business. Businesses that honor at least one of the loyalty programs listed in the loyalty programs associated with the user are identified in step 640.

The identified business within the predetermined proximity to the user are selected in step 650. Alternatively, the identified business within the predetermined proximity to a location supplied by the user are selected in step 650. The selected businesses are provided to the user in step 660. The selected businesses can be provided in a list, shown on a map, or both provided in a list and shown on a map.

A number of businesses provided to the user in step 660 can be limited to help avoid providing an overly long list of businesses or a confusing and cluttered map to the user. For example, the number of provided businesses can be limited to a predefined number. For another example, the provided businesses can be limited to only businesses associated with loyalty programs that the user has used in a certain period of time. Alternatively, the provided businesses can be limited by excluded those businesses that have loyalty programs that the user has already used at the businesses. For yet another example, the businesses can be limited to those where the available loyalty offers have at least a certain reward value. These and other limiting operations can be combined, for example limiting the businesses to the top 5, 10, or some other number of businesses with the highest valued reward offers. Other techniques for limiting the number of businesses provided to the user also can be used.

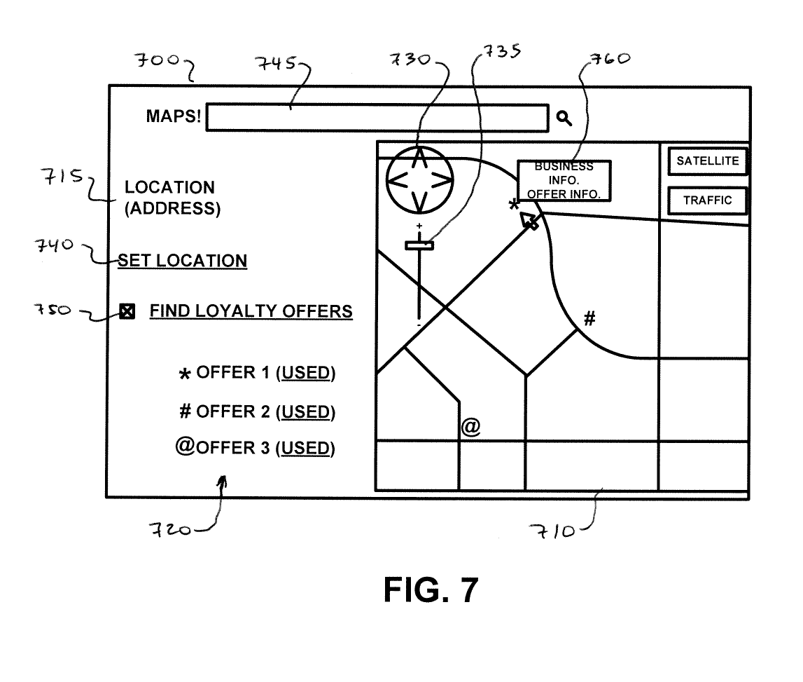

FIG. 7 is an illustration of an example of a map-based interface that can be used to present information about businesses that honor a user's loyalty programs according to certain aspects of the disclosure. Maps interface 700 can be generated for display on a client device by a server for a map website. The map interface also can be provided locally and can be provided in other ways as well.

The interface in FIG. 7 includes map 710 corresponding to a geographic location 715 of a user such as a consumer. For example, the geographic location can be a location of a user provided by a location aware device such as but not limited to a GPS enabled smart phone or other mobile device. For another example, the geographic location can be a location entered by a user into a web site as part of a search for a geographic area. The location can come from other sources as well.

The map includes symbols indicating businesses that honor one or more of a user's loyalty programs, for example with loyalty offers. Such symbols are illustrated in FIG. 7 as *, @, and #. Other techniques can be used to designate businesses that honor the user's loyalty programs, for example blinking icons, different color icons, and the like.

The businesses and associated offers are displayed in list 720 with symbols corresponding to those used in map 710. List 720 also shows links denoted “USED)” that provide one possible way for a user to indicate that a loyalty program has been used at a business. Other ways of designating that a loyalty program has been used can be provided.

In other approaches, only the map or the list can be shown. Business that honor at least one of a user's loyalty programs can be provided for display in other ways, for example but not limited to via audio.

Controls for changing an area shown by the map can be included, for example pan control 730, zoom control 735, set location link 740, and search bar 745. Changing the area can change what businesses are displayed by the map interface. For example, panning can change a location for the user, and zooming can change a proximity around the location for which businesses that honor the user's loyalty programs are identified and selected for display.

Check box 750 in FIG. 7 is used to specify that businesses honoring the user's loyalty programs should be found and displayed to the user. Alternatively, finding and displaying such businesses can be a default or a profile setting. Other approaches can be used to determine whether or not to find and display businesses based on loyalty programs.

Likewise, additional functionality can be provided by interface 700. For example, pop-up 760 displays business and loyalty program information when a symbol on map 710 is hovered over with a cursor. Other map features such as show satellite imagery, show traffic, and the like also can be provided by the map interface. Map interfaces according to aspects of the present technology can include some or all of the foregoing elements. Other elements also can be included.

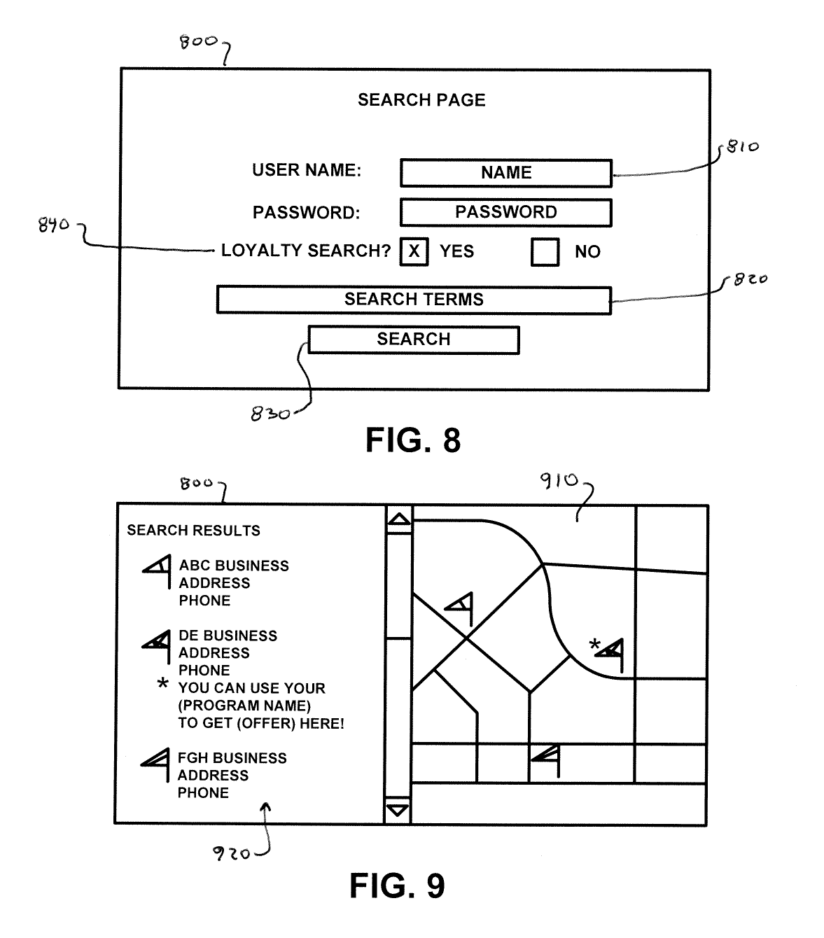

FIGS. 8 and 9 are illustrations of an example search-based interface that can be used to present information about businesses that honor a user's loyalty programs according to certain aspects of the disclosure. Search interface 800 is generated for display on a client device by a server for a search engine provider, for example a website that provides search services. The search interface also can be provided locally and can be provided in other ways as well.

The interface in FIG. 8 includes sign on area 810, search term entry area 820, and search button 830. Activation of search button 830 causes a search engine to search a database for websites and other information matching search criteria entered into search term entry area 820.

Interface 800 is also shown including loyalty search option 840. Checking this option enables a loyalty program based search according to certain aspects of this disclosure. Other techniques for enabling a loyalty program based search can be used. When a loyalty program based search is enabled, the search engine tailors its search to look for businesses that honor at least one of the user's loyalty programs within some proximity to a location. This location can be a location of a user or a location entered by a user. The location can come from other sources as well.

After the search is performed, interface 800 displays results 900 shown in FIG. 9. In the example shown in results 900, both businesses that honor at least one loyalty program associated with the user and other businesses are shown. These businesses are shown on map 910 and in list 920. The businesses honoring one or more of the user's loyalty programs are designated with a marker shown in the form of an asterisk on the map and in the list. Other techniques can be used to highlight businesses that honor a user's loyalty programs, for example blinking icons, different color icons, separate lists, and the like. In other approaches, only the map or the list could be shown. Other ways of providing the business and offer information to a user can be used, for example but not limited to via audio.

The operations described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., communication network [#]50) can include, for example, any one or more of a personal area network (PAN), a local area network (LAN), a campus area network (CAN), a metropolitan area network (MAN), a wide area network (WAN), a broadband network (BBN), the Internet, and the like. Further, the network can include, but is not limited to, any one or more network topologies such as a bus network, a star network, a ring network, a mesh network, a star-bus network, tree or hierarchical network, and the like. The communications modules can be, for example, modems or Ethernet cards.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer-implemented method of identifying businesses that honor loyalty programs, the method comprising:
receiving, using one or more processors, a request for businesses located within a predetermined proximity of a user that have a loyalty program included within a predetermined list of loyalty programs associated with the user, the request including location information of the user;
accessing, using the one or more processors, the predetermined list of loyalty programs associated with the user;
comparing, using the one or more processors, the predetermined list of loyalty programs associated with the user to businesses listings in a business data repository, each business listing having an associated address and a list of loyalty programs honored by the business;
identifying, using the one or more processors, those businesses that honor at least one of the loyalty programs listed in the predetermined list of loyalty programs associated with the user;
selecting, using the one or more processors, the identified businesses that are within the predetermined proximity to the user;
determining, using the one or more processors, which of the selected businesses honor a loyalty program that the user has previously used within a predetermined time period; and
providing, using the one or more processors, a list of one or more of the selected businesses to the user, wherein the provided list is limited to only the selected businesses determined to honor a loyalty program that the user has previously used within the predetermined time period.

2. The method of claim 1, wherein the location information of the user comprises an address of the user.

3. The method of claim 2, wherein the address is provided by a location aware device.

4. The method of claim 1, wherein the location information of the user comprises an address provided by the user.

5. The method of claim 4, wherein the address is provided by the user through a website.

6. The method of claim 5, wherein the website comprises a map website.

7. The method of claim 5, wherein the website comprises a search engine website.

8. The method of claim 1, further comprising providing, using the one or more processors, a map showing the selected businesses to the user.

9. A system for identifying businesses that honor loyalty programs, the system comprising:
one or more processors; and
a machine-readable medium comprising instructions stored therein, which when executed by the one or more processors, cause the processors to perform operations comprising:
receiving a request for businesses located within a predetermined proximity to a location that have a loyalty program included within a predetermined list of loyalty programs associated with a user, the request including information from the user about the location;
accessing the predetermined list of loyally programs associated with the user;
comparing the predetermined list of loyalty programs associated with the user to businesses listings in a business data repository, each business listing having an associated address and a list of loyalty programs honored by the business;
identifying those businesses that honor at least one of the loyalty programs listed in the predetermined list of loyalty programs associated with the user;
selecting the identified businesses that are within the predetermined proximity to the location;
determining which of the selected businesses honor a loyalty program that the user has previously used within a predetermined time period; and
providing a list of one or more of the selected businesses to the user, wherein the provided list is limited to only the selected businesses determined to honor a loyalty program that the user has previously used within the predetermined time period.

10. The system of claim 9, wherein the information about the location comprises an address provided by the user.

11. The system of claim 10, wherein the address is provided by the user through a website.

12. The system of claim 11, wherein the website comprises a map website.

13. The system of claim 11, wherein the website comprises a search engine website.

14. The system of claim 9, further comprising providing a map showing the selected businesses to the user.

15. A non-transitory machine-readable medium comprising instructions stored therein, which when executed by a machine, cause the machine to perform operations for identifying businesses that honor loyalty programs, the operations comprising:
Receiving a request for businesses located within a predetermined proximity of a user that have a loyalty program included within a predetermined list of loyalty programs associated with the user, the request including location information of the user;
accessing the predetermined list of loyalty programs associated with the user;
comparing the predetermined list of loyalty programs associated with the user to businesses listings in a business data repository, each business listing having an associated address and a list of loyalty programs honored by the business;
identifying those businesses that honor at least one of the loyalty programs listed in the predetermined list of loyalty programs associated with the user;
selecting the identified businesses that are within the predetermined proximity to the user;
determining which of the selected businesses honor a loyalty program that the user has previously used within a predetermined time period; and
providing a map showing one or more of the selected businesses to the user, wherein the provided list is limited to only the selected businesses determined to honor a loyalty program that the user has previously used within the predetermined time period.

16. The machine-readable medium of claim 15, wherein the location information of the user comprises an address of the user.

17. The machine-readable medium of claim 16, wherein the address is provided by a location aware device.

18. The machine-readable medium of claim 15, wherein the location information of the user comprises an address provided by the user.

19. The machine-readable medium of claim 18, wherein the address is provided by the user through a website.

20. The machine-readable medium of claim 19, wherein the website comprises a map website.

21. The machine-readable medium of claim 19, wherein the website comprises a search engine website.

22. The machine-readable medium of claim 15, further comprising providing a list of the selected businesses to the user.

23. (canceled)
